(19) United States
(12) Patent Application Publication
(10) Pub. No.: US 2022/0209873 A1
(43) Pub. Date: Jun. 30, 2022

(54) ANALYZING THE FREQUENCY STABILITY OF RADIO TRANSCEIVER APPARATUS

(71) Applicant: Nordic Semiconductor ASA, Trondheim (NO)

(72) Inventor: Daniel James Ryan, Trondheim (NO)

(73) Assignee: Nordic Semiconductor ASA, Trondheim (NO)

(21) Appl. No.: 17/553,501

(22) Filed: Dec. 16, 2021

(30) Foreign Application Priority Data
Dec. 18, 2020 (GB) 2020139.8

(51) Int. Cl. H04B 17/10; H04B 17/11; H04B 1/18

(52) U.S. Cl. CPC H04B 17/104; H04B 1/18; H04B 17/11

(57) ABSTRACT

A method for analyzing a frequency stability of a radio transceiver device comprises receiving a first succession of unmodulated radio-frequency signals of different frequencies from a radio transceiver apparatus. For each unmodulated radio-frequency signal, a respective time series of phase-offset values is determined, each phase-offset value being representative of a difference between a phase of the respective received unmodulated radio-frequency signal and a phase of a respective reference signal. The time series of phase-offset values is processed to determine a respective signal-phase-offset value for each unmodulated radio-frequency signal. A frequency-stability value, representative of a frequency stability of the radio transceiver apparatus, is calculated as a function representative of statistical variation in the signal-phase-offset values determined for the first succession of unmodulated radio-frequency signals.

### CROSS-REFERENCE TO RELATED APPLICATION

This application claims priority from United Kingdom Patent Application No. GB2020139.8, filed Dec. 18, 2020, which application is incorporated herein by reference in its entirety.

### BACKGROUND OF THE INVENTION

This invention relates to methods and apparatus for analyzing the frequency stability of radio transceiver apparatus.

Certain radio transceiver devices are capable of implementing multicarrier phase-based ranging processes to measure the separation distance between a pair of such devices.

In a phase-based ranging process, unmodulated radio carrier signal (i.e. pure sine-wave tones), are transmitted between two radio transceiver devices, over a number of different frequencies. The device receiving a particular signal measure a phase offset between the signal and a locally-generated reference signal. By transmitting unmodulated signals in both directions, and on two or more different frequencies, it is possible to collect sufficient phase offset measurements to be able to calculate the separation distance, even when the two devices have unsynchronized clocks.

Phase-based ranging differs from time-of-flight ranging, in which a separation distance is calculated from time-of-transmission and time-of-arrival measurements, using the known speed of light. Phase-based ranging also differs from radar ranging, in which a radar device receives reflections of radio signals off a target, since, in phase-based ranging, radio waves are transmitted directly from radio transmitter unit to a separate radio receiver unit.

When the devices are not synchronized, the frequencies of the unmodulated carrier signals they transmit may not be perfectly aligned. In order to adjust for this, one of the transceiver devices can estimate a fractional frequency offset of its local oscillator relative to a local oscillator of the other device, by processing one or more unmodulated carrier signals received from the other device. This may be done during an initial calibration stage, before further unmodulated carrier signals are exchanged as part of a ranging stage.

In order to achieve accurate ranging, it is important that the frequencies of the signals transmitted by the two devices remain stable over time, so that an initial frequency adjustment factor remains valid over the duration of the whole ranging process.

It can therefore be desirable to test the frequency stability of a radio transceiver apparatus to ensure that it meets a required standard. Desirably, this testing would be performed while simulating an actual multicarrier phase-based ranging process—i.e. using transmission timings that are consistent with normal usage.

However, this is not straightforward, since the duration of each unmodulated carrier transmission may be very short, e.g. being as short as 10 μs when transmitting carriers in the 2.4 GHz band. It is not easy for a test apparatus to collect accurate measurements of frequency offset from such short-duration signals, in order to determine how stable they are over the course of the ranging process.

Embodiments of the present invention therefore seek to provide an approach to analyzing the frequency stability of a radio transceiver apparatus that can be performed using radio transmissions of relatively short duration.

### SUMMARY OF THE INVENTION

From a first aspect, the invention provides a method for analyzing a frequency stability of a radio transceiver apparatus, the method comprising:
receiving a first succession of unmodulated radio-frequency signals of different frequencies from a radio transceiver apparatus;
for each unmodulated radio-frequency signal, determining a respective time series of phase-offset values, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculating a frequency-stability value, representative of a frequency stability of the radio transceiver apparatus, as a function representative of statistical variation in the signal-phase-offset values determined for the first succession of unmodulated radio-frequency signals.

From a second aspect, the invention provides an analysis apparatus for analyzing a frequency stability of a radio transceiver apparatus, the analysis apparatus comprising:
an interface for receiving a first succession of unmodulated radio-frequency signals of different frequencies from a radio transceiver apparatus;
an analog-to-digital converter for generating digital data representative of the first succession of received unmodulated radio-frequency signals; and
a processing system,

wherein the processing system is configured to process the digital data to:
determine a respective time series of phase-offset values for each unmodulated radio-frequency signal, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculate a frequency-stability value, representative of a frequency stability of the radio transceiver apparatus, as a function representative of statistical variation in the signal-phase-offset values determined for the first succession of unmodulated radio-frequency signals.

From a third aspect, the invention provides software comprising instructions which, when executed by a processor, cause the processor to process digital data representative of a first succession of unmodulated radio-frequency signals, received from a radio transceiver apparatus, to:
determine a respective time series of phase-offset values for each unmodulated radio-frequency signal, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculate a frequency-stability value, representative of a frequency stability of the radio transceiver apparatus, as a function representative of statistical variation in the signal-phase-offset values determined for the first succession of unmodulated radio-frequency signals.

Thus it will be seen that, in accordance with aspects of the invention, frequency stability is measured by analyzing the statistical variation of the phase offset (i.e. phase error) between received signals and reference signals over time, rather than by estimating a succession of frequency offsets over time. In contrast to estimating frequency offsets, which requires a large number of signal samples to be reliable, it is possible to compare the phase of a received signal with the phase of a reference signal nearly instantaneously—e.g. once every microsecond—allowing a succession of phase-offset values to be determined even within the duration of a relatively short unmodulated signal (e.g. a 10 microsecond signal).

The method advantageously does not require a true, absolute phase to be determined and corrected for, but only relies on the variation within the phase-offset values. It does not require the analysis apparatus and the transceiver to have phase-synchronized clocks, and does not require all the phase delays in the RF test path (e.g. arising from signal delays, impedance mismatches, etc.) to be known and corrected for.

In a first set of embodiments, the analysis apparatus may be separate from the radio transceiver apparatus. The radio transceiver apparatus may be a radio transceiver device. The analysis apparatus may be a distinct analysis device or unit, such as a signal analyzer. The analysis apparatus may be arranged to receive the unmodulated radio-frequency signals from the radio transceiver device over a wired or wireless connection.

In a second set of embodiments, a single radio transceiver device may comprise both the radio transceiver apparatus and part or all of the analysis apparatus (e.g. in a common housing and/or configured to be powered by a common power supply). The radio transceiver device may comprise all of the analysis apparatus, or it may comprise at least the input and the analog-to-digital converter of the analysis apparatus with some or all of the processing system of the analysis apparatus being remote from the radio transceiver device. The input to the analysis apparatus may be internal to the radio transceiver device—i.e. an internal interface. The analysis apparatus may receive the unmodulated radio-frequency signals over this internal input. The unmodulated radio-frequency signals may also be transmitted externally from the radio transceiver apparatus, e.g. as radio signals from an antenna of the radio transceiver apparatus, but this is not essential.

At least part of the analysis apparatus and at least part of the radio transceiver apparatus may be provided by a common integrated circuit. The analysis apparatus may comprise circuitry that is integrated with circuitry of the radio transceiver apparatus on a common semiconductor chip. One or more components of the analysis apparatus (e.g. a mixer) may also be used by the radio transceiver device for a purpose other than analyzing the frequency stability of the radio transceiver apparatus. However, one or more components of the analysis apparatus (e.g. one or more software routines) may be used only for analyzing the frequency stability of the radio transceiver apparatus.

Providing the analysis apparatus and radio transceiver apparatus as a single radio transceiver device can allow the radio transceiver device to analyze its own frequency stability. This may facilitate faster or cheaper testing of radio transceiver devices, e.g. by allowing multiple radio transceiver devices to be tested in parallel during a production process. It may also facilitate self-testing of frequency stability in a post-production setting; this may be useful for periodically re-evaluating performance after deployment in the field.

In both sets of embodiments, the analysis apparatus may comprise a local oscillator and a mixer, which may be an analog mixer. The analysis apparatus may be arranged to use the local oscillator and the mixer to down-mix the received unmodulated radio-frequency (RF) signals. It may mix the signals to baseband (i.e. zero intermediate frequency) or to a non-zero intermediate frequency (IF). The method may comprise sampling the received unmodulated radio-frequency signals (directly or after analog down-mixing) to generate digital data representative of the signals. In non-zero IF embodiments, the analysis apparatus may comprise a digital mixer for converting the digital signals to baseband. The analysis apparatus may comprise a clock that is synchronized with the local oscillator. The sampling of the received signals may be clocked by this clock. The processor or processing system of the analysis apparatus may be clocked by this clock.

The analysis apparatus preferably comprises a local oscillator that is not shared with the radio transceiver apparatus. This is preferably the case even in embodiments where the analysis apparatus and radio transceiver apparatus are embodied in the same physical device. Nevertheless, in some such embodiments the local oscillator of the analysis apparatus and a local oscillator of the radio transceiver apparatus may receive a clock signal from a common clock source—e.g. from the same crystal oscillator. However, the two local oscillators are preferably decoupled or quasi-decoupled in phase, and they are preferably offset from each other in phase by an amount that varies with frequency (i.e. they exhibit different frequency-dependent phase behavior). When using a common clock signal, a first of the local oscillators (e.g. that of the radio transceiver apparatus) may be a PLL-based local oscillator; it may be arranged to generate RF signals from the clock signal using a voltage-controlled oscillator (VCO) and a phase-locked loop (PLL). The other of the local oscillators (e.g. that of the analysis apparatus) may instead be a harmonic-based local oscillator; it may be arranged to generate RF signals as harmonics of the clock signal, e.g. by generating a harmonic-containing signal from the clock signal (e.g. a square wave). In some embodiments, the harmonic-containing signal may be filtered to remove some or all frequencies outside a desired RF component. Such filtering may be provided by a dedicated analog filtering stage (e.g. a tunable RF bandpass filter), or may be provided inherently by the radio transceiver apparatus, e.g. by a low-noise amplifier (LNA) of the radio transceiver apparatus, having a finite bandwidth.

In general, the reference signals may be determined by the analysis apparatus—e.g. using a clock of the analysis apparatus. They may be represented by analog signals, or by digital signals, or by a combination of both analog and digital signals (e.g. if each received unmodulated RF signal is down-mixed using an analog local-oscillator signal and is then further down-mixed using a digital clock signal). The reference signals may be at least partly defined by a sequence of complex digital values generated by the analysis apparatus.

The reference signals may be generated or determined using a frequency adjustment factor. The adjustment factor may represent a fractional frequency offset between a local oscillator of the radio transceiver apparatus and a nominal frequency or a local oscillator of the analysis apparatus, e.g. arising due to an inaccuracy in a quartz crystal oscillator in the transceiver apparatus. In some embodiments and/or modes of operation (e.g. when testing a “reflector” device, as described below), the adjustment factor may be determined by the analysis apparatus, e.g. by the analysis apparatus determining a frequency offset from one of more unmodulated radio-frequency signals received from the transceiver apparatus. These signals may be received during a calibration stage. They may each be of a longer duration than the unmodulated signals used to determine the phase-offset values.

In other embodiments and/or modes of operation (e.g. when testing an “initiator” device, as described below), the adjustment factor may be predetermined (e.g. from data stored in a memory of the analysis apparatus) and may be communicated by the analysis apparatus to the transceiver apparatus. The transceiver apparatus may use the received adjustment factor when outputting the unmodulated radio-frequency signals to the analysis apparatus.

In any of these embodiments and/or modes of operation, the analysis apparatus may use the frequency adjustment factor when down-mixing the unmodulated signals from which the phase-offset values are determined (using analog and/or digital mixing). In some embodiments, it may use the adjustment factor to determine the frequency of an analog mixing signal, generated by a local oscillator of the analysis apparatus, which it may use when receiving and/or transmitting unmodulated radio-frequency signals. It may displace the local-oscillator frequency from a nominal frequency by an amount that depends on the frequency adjustment factor.

Each respective reference signal may represent a frequency that is equal to a nominal frequency for the respective unmodulated radio-frequency signal, scaled by the frequency adjustment factor. If the transceiver apparatus exhibits no frequency instability, there should then be no frequency offset between each received signal and the respective reference signal, once the frequency adjustment factor has been applied, meaning that the phase offset between each received signal and the respective reference signal should then be constant. However, in practice, this will not typically be the case, and the deviation in the phase offset can therefore be used by the analysis apparatus to quantify the degree of frequency stability or instability exhibited by the transceiver apparatus.

The time series of phase-offset values may be determined for regular time intervals over each unmodulated signal—e.g. one value every one microsecond. They may be determined by integrating samples generated by the analog-to-digital converter. A plurality, e.g. ten, thirty, a hundred or more, may be determined for each unmodulated signal.

In some embodiments, the time series of phase-offset values may be normalized. Each phase-offset value, associated with an unmodulated signal, may be normalized by determining a respective principal angle of the difference between the phase-offset value and the mean of the time series of phase-offset values for the unmodulated signal.

Processing the time series of phase-offset values to determine a respective signal-phase-offset value for each unmodulated signal of the first succession of unmodulated signals may comprise integrating each time series of phase-offset values over the duration of the respective unmodulated signal for the time series, thereby determining a first integral. It may further comprise determining a respective principal angle of the difference between the first integral and a second integral, wherein the second integral is an integral of a second time series of phase-offset values. The second time series of phase-offset values may be representative of a difference between a phase of a second unmodulated radio-frequency signal, received from the radio transceiver apparatus, and a phase of a respective second reference signal. The second unmodulated radio-frequency signal may be one or a second succession of unmodulated radio-frequency signals, of different frequencies, received from the radio transceiver apparatus. The second succession of signals may be received interleaved with the first succession of unmodulated signals, with each unmodulated signal of the first succession having a corresponding unmodulated signal of the second succession. Each corresponding second signal may be received before the respective first signal (e.g. when testing a “reflector” transceiver device in accordance with a two-way ranging protocol) or each corresponding second signal may be received after the respective first signal (e.g. when testing a “initiator” transceiver device in accordance with a two-way ranging protocol). The first and second signals may have the same respective frequency, for each pair of first and second signals. The radio transceiver apparatus may output the second signals at times when the transceiver apparatus would normally receive an unmodulated signal during a ranging process.

Information relating to the time intervals between the first succession of unmodulated RF signals and the second succession of unmodulated RF signals may be used by the analysis apparatus when determining the signal-phase-offset values. This timing information may be shared between the radio transceiver apparatus and the analysis apparatus—e.g. over a wired or wireless channel.

The function representative of statistical variation in the signal-phase-offset values may represent any measure of statistical variation, such as standard deviation, variance, range, interpercentile range, or mean deviation. In a preferred set of embodiments, the function equals or is representative of the standard deviation or variance of the signal-phase-offset values for the succession of unmodulated signals (i.e. for the particular analysis process). In this way, the frequency-stability value may correspond to the standard deviation of the phase error of the transceiver apparatus over the first succession of unmodulated RF carriers. The function may be evaluated using a corresponding algorithm.

Determining the signal-phase-offset values may be performed separately from calculating the frequency-stability value (e.g. performed earlier in time, or with data representative of the signal-phase-offset values being stored in a memory of the analysis apparatus), or it may be integrated within the process of determining the frequency-stability value (e.g. without the values being explicitly calculated and stored separately). More generally, it will be appreciated that there may be many mathematically-equivalent ways to calculate a particular frequency-stability value, from the time series of phase-offset values, and embodiments are not limited to any particular approach.

Analyzing the frequency stability of the radio transceiver apparatus may further comprise determining whether the frequency-stability value satisfies a test criterion, such as being below a predetermined threshold. The analysis apparatus may be configured to identify or signal whether the frequency-stability value meets the test criterion. The analysis apparatus may be configured to identify or signal the radio transceiver apparatus as meeting a qualification criterion when the value meets the test criterion—e.g. by outputting a first type of visual or audible or electrical signal, or by storing a first data value in a memory of the analysis apparatus. It may be configured to identify or signal the radio transceiver apparatus as not meeting the qualification criterion when the value does not meet the test criterion—e.g. by outputting a second type of visual or audible or electrical signal, or by storing a second data value in a memory of the analysis apparatus. In some embodiments the analysis apparatus may be configured to receive a plurality of first successions of unmodulated radio-frequency signals—e.g. over a succession of test processes—and to calculate a corresponding plurality of frequency-stability values. The analysis apparatus may be configured to determine whether a root-mean-square value of the plurality of frequency-stability values is below a threshold, and to identify or signal the radio transceiver apparatus as meeting a qualification criterion when the value is below the threshold. In some embodiments, the threshold may be 5.73 degrees.

In some embodiments, the analysis apparatus may be configured to calculate a plurality of frequency-stability values for each of a corresponding plurality of different frequency adjustment factors. The analysis apparatus may use reference signals having frequencies adjusted by a different respective frequency-stability value when calculating each respective frequency-stability value. The analysis apparatus may calculate each frequency-stability value by determining a plurality of time series of phase-offset values for each unmodulated signal, for the different reference signals, and determining a corresponding plurality of signal-phase-offset values. It may calculate each frequency-stability value as a function representative of statistical variation in the respective plurality of signal-phase-offset values. The analysis apparatus may be configured to determine whether all of the calculated frequency-stability values satisfy a test condition, such as all being below a threshold. It may be configured to identify or signal whether or not all of the frequency-stability values satisfy the test condition.

The unmodulated radio-frequency signals may be wireless signals or wired electrical signals. The input of the analysis apparatus may comprise a wireless interface for receiving radio-frequency signals wirelessly from the radio transceiver apparatus (e.g. as radio waves at an antenna, or at an antenna coupler using near-field coupling), or it may comprise an electrical input for receiving electrical RF signals from the radio transceiver apparatus. This may be over an electrical cable from an external radio transceiver device, or an internal electrical connection from circuitry of the radio transceiver apparatus in embodiments where the analysis apparatus is incorporated into a radio transceiver device capable of performing a self-test.

The first succession of unmodulated radio-frequency signals may have a plurality of different frequencies. They may be sent at regular or predetermined time intervals. The analysis apparatus may comprise an interface for sending timing data related to times of transmission for the unmodulated signals to the transceiver apparatus and/or for receiving timing data related to times of transmission of the unmodulated signals from the transceiver apparatus. The interface may be a radio interface or an electrical interface. The analysis apparatus may use the timing data when generating the reference signals.

In some embodiments, the analysis apparatus may be configured only to receive RF signals from the radio transceiver apparatus—i.e. not being configured for sending RF signals to the radio transceiver apparatus. This can enable the analysis apparatus to comprise a signal analyzer. The analysis apparatus may be implemented by loading suitable software to a conventional signal analyzer, which may be incapable of generating and outputting RF signals. This can significantly reduce test complexity compared with tests that require bidirectional RF communication, enabling lower-cost implementations. Thus in some methods the frequency stability of the radio transceiver apparatus may be determined using a signal analyzer.

The radio transceiver apparatus may be configured to perform a multicarrier phase-based ranging process. The first succession of unmodulated radio-frequency signals may be signals from a multicarrier phase-based ranging protocol. They may be signals transmitted by an initiator device in a two-way multicarrier phase-based ranging protocol, or they may be signals transmitted by a reflector device in a two-way multicarrier phase-based ranging protocol.

The radio transceiver apparatus may support a Bluetooth™ radio protocol. It may support Bluetooth™ Low Energy.

The processing system of the analysis apparatus may comprises a processor and a memory storing software for execution by the processor. It may alternatively or additionally comprise dedicated circuitry, e.g. logic gates separate from any processor, for processing the data representative of the received signals. Where the analysis apparatus is provided by the same radio transceiver device as the radio transceiver apparatus, the processing system may comprise a dedicated processor or may comprise a processor that is shared with the radio transceiver apparatus. The software of the analysis apparatus may be separate from software of the radio transceiver apparatus (e.g. comprising separate executable binaries) or they may be provided by a common executable binary.

The processing system or the analysis apparatus may comprise any one or more of: processors, DSPs, FPGAs, logic gates, local oscillators, amplifiers, mixers, filters, digital components, analog components, non-volatile memories (e.g., for storing software instructions), volatile memories, memory buses, peripherals, inputs, outputs, and any other relevant electronic components or features. The analysis apparatus may comprise a housing surrounding some or all of the analysis apparatus. The analysis apparatus may comprise a sampling unit, comprising the input for receiving the unmodulated RF signals and the analog-to-digital converter for generating digital data representative of the signals.

The software may be stored on a non-transitory computer-readable medium.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of a radio communication system that implements multicarrier phase-based ranging;

FIG. 2 is a schematic diagram of a radio transceiver that implements multicarrier phase-based ranging;

FIG. 3 is a sequence diagram of a multicarrier phase-based ranging process;

FIG. 4 is a schematic diagram of a first test set-up, embodying the invention, for testing a radio transceiver configured for multicarrier phase-based ranging;

FIG. 5 is a schematic diagram of a second test set-up, embodying the invention, for testing a radio transceiver configured for multicarrier phase-based ranging;

FIG. 6 is a schematic diagram of a third test set-up, embodying the invention, for testing a radio transceiver configured for multicarrier phase-based ranging;

FIG. 7 is a schematic diagram of a fourth test set-up, embodying the invention, for testing a radio transceiver configured for multicarrier phase-based ranging;

FIG. 8 is a sequence diagram of a test method, embodying the invention, for testing a radio transceiver configured as a reflector in a multicarrier phase-based ranging process; and

FIG. 9 is a sequence diagram of a test method, embodying the invention, for testing a radio transceiver configured as an initiator in a multicarrier phase-based ranging process.

### DETAILED DESCRIPTION

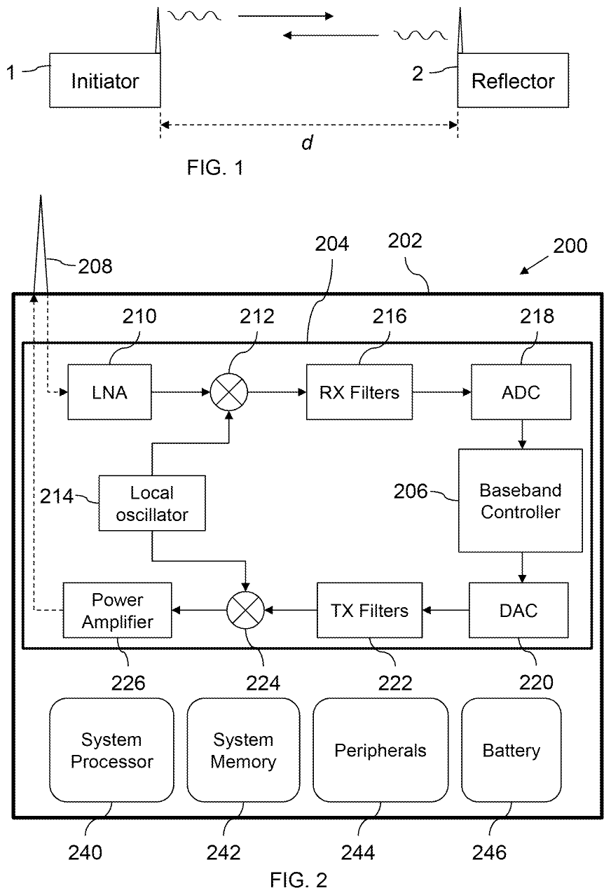

FIG. 1 shows two radio transceiver devices 1, 2 configured to act as an “initiator” transceiver 1 and a “reflector” transceiver, respectively, in a multicarrier phase-based ranging process for estimating a separation distance, d, between the devices 1, 2. This distance could be of the order of centimeters, meters, kilometers, tens of kilometers, hundreds of kilometers or more.

The devices 1, 2 may be any radio-equipped devices, such as smartphones, wireless sensors, household appliances, land vehicles, satellites, etc. In one set of embodiments, the devices 1, 2 are consumer electronics products, and can communicate with each other over a Bluetooth™ Low Energy communication link.

The devices 1, 2 typically do not have synchronized clocks and local oscillators, and so a two-way ranging protocol can be used that does not rely on synchronization. To measure the distance d, the initiator device 1 sends a first unmodulated radio signal—i.e. a pure continuous sine-wave carrier—of frequency f_{I}, for a predetermined duration. It may generate this signal directly by amplifying the output of a local oscillator, or it could pass a stream of constant bit values (e.g. all “1”s) through a frequency-shift-key modulator in the device 1. The radio signal is received by a reflector device 2 which measures the phase of the received signal relative to a signal generated using a local oscillator of the reflector 2. The reflector 2 then transmits a second unmodulated radio signal of frequency f_{R} to the initiator 1, which measures a second phase relative to its local oscillator.

A succession of such two-way radio exchanges are performed across a plurality of different initiator carrier frequencies. One of the devices, e.g. the reflector 2, sends its phase measurements by radio to the other device, e.g. the initiator 1, which combines them with its own phase measurements in order to estimate the distance, d. By performing the exchanges over two or more initiator carrier frequencies, the distance can be determined unambiguously, rather than modulo a wavelength. Performing further exchanges, using different initiator frequencies, can provide redundancy that can help mitigate against interference and multipath fading.

Assuming no multipath interference, noise or other impairments, the sum Ψ of the phase differences measured at each device 1, 2 for a particular carrier frequency, is related to the distance, d, between the devices 1, 2 by

$$ψ \approx - \frac{2 π d ( {f}_{I} + {f}_{R} )}{c} - 2 πΔ fT + C \qquad ( 1 )$$

where f_{I} and f_{R} are the signal frequencies transmitted by the initiator 1 and reflector 2 respectively, and also used for determining the phase offset measurements. T is the time between phase measurements, Δf is the offset between f_{I} and f_{R}, and C is a constant.

If Δf=0, the time dependence disappears. Because the devices 1, 2 are not synchronous, it is desirable to minimize Δf so that the time dependence is sufficiently small that it can be disregarded while preserving a desired level of accuracy in the distance estimation.

This can be done by performing a calibration stage, before the main two-way ranging stage, in which the reflector 2 sends one or more unmodulated calibration signals to the initiator 1. The initiator 1 calculates a fractional frequency offset (FFO) relative to its local oscillator in an initial state and then uses this to adjust its local oscillator so that the set of frequencies it transmits in the ranging stage more closely equal the frequencies that the reflector 2 will transmit in response. It also uses the adjusted local oscillator frequencies when down-mixing incoming signals received from the reflector 2.

In order to keep Δf as close to zero as possible during the ranging stage, it is desirable for both the initiator device 1 and the reflector device 2 to have good frequency stability, so that the fractional frequency offset value measured during the calibration stage remains accurate over the duration of the ranging stage.

An analysis apparatus and methodology for testing the frequency stability of one or both of the initiator device 1 and the reflector device 2 will be described further below. First, approaches that use external analysis apparatus will be described. Then an approach will be described in which the device is arranged to provide on-board analysis apparatus, for supporting self-testing.

FIG. 2 shows the major components of an exemplary representative radio device 200, which could act as the initiator device 1 or as the reflector device 2 in a phase-based ranging process.

The radio device 200 contains, within a housing 202, an integrated-circuit radio transceiver chip 204 that supports Bluetooth™ Low Energy communications. It may additionally support other radio protocols such as IEEE 802.11, 3GPP LTE Cat-M1, 3GPP LTE NB-IoT, IEEE 802.15.4, Zigbee™, Thread™, ANTI™, etc.

The radio chip 204 contains a baseband controller 206, which includes dedicated hardware logic, as well as memory for storing software, and a processor for executing the software, such as an Arm™ Cortex™ processor. It may include one or more DSPs or further processors. The baseband controller 206 is connected to one or more radio antennae 208 by a transmit path, for transmitting radio data, and by a receive path, for receiving incoming radio data. The receive path includes a low-noise amplifier (LNA) 210, a quadrature mixer 212 for analog downmixing of an incoming radio-frequency (e.g. 2.4 GHz) signal to an intermediate frequency (IF) or to baseband by mixing the RF signal with a periodic signal generated by a PLL-based local oscillator 214, a set of analog receive filters 216, and an analog-to-digital converter (ADC) 218. When using a non-zero IF, further mixing to baseband may be performed digitally.

In the example of FIG. 2, the transmit path includes a digital-to-analog converter (DAC) 220, a set of analog transmit filters 222, a quadrature mixer 224 for up-mixing a baseband signal to a radio frequency (RF) signal using a periodic signal generated by the local oscillator 214, and a power amplifier (PA) 226.

Alternatively, in other embodiments, instead of using a DAC 220, transmit filters 222 and quadrature mixer 224, the radio transceiver device may be arranged for directly modulating a local-oscillator frequency by a message signal, such that the output of the PLL-based local oscillator 226 may be a modulated signal with constant envelope which is directly passed to the power amplifier 226. In this way the local oscillator 226 may be capable of generating a sine wave signal at a frequency that is directly controlled by a digital signal output by the baseband controller 206 (i.e. based on frequency codewords derived from modulator bits) without the need for mixing.

The transmit and receive paths may also include components, not shown in FIG. 2, such as RF filtering between the antenna 208 and the LNA 210 or PA 226.

The baseband controller 206 performs digital operations for the transmit and receive paths. On the receive path, it provides optional digital mixing and filtering and GFSK demodulation. On the transmit path, it provides GFSK modulation and digital filtering. It may also perform higher-level operations such as assembling and disassembling data packets, generating and verifying checksums, cryptographic operations, etc. In some embodiments it may implement a full Bluetooth™ Low Energy protocol stack.

When receiving a radio signal, the device 200 down-mixes the incoming RF signal using the receive mixer 212. It samples the down-mixed signal using the ADC 218 in order to generate a digital representation of the signal. The sampled signal can be digitally filtered and GFSK-demodulated in the baseband controller 206. When transmitting a radio signal, the baseband controller 206 outputs digital samples representing a GFSK-modulated signal to the DAC 220. These are then filtered by the transmission filters 222 and up-mixed by the mixer 224 for transmission.

The baseband controller 206 is able to set the frequency of the local oscillator 214 to different frequencies for transmitting at different carrier frequencies, and for down-mixing received signals using different mixing frequencies.

The chip 204 may optionally include further processors, volatile memory, non-volatile memory, peripherals, or other components, integrated on the same chip as the radio transceiver circuitry, for performing additional functions.

The radio device 200 in this example also contains—separate from the radio chip 204—a system processor 240, system memory 242, which may include volatile memory (e.g., RAM) and/or non-volatile memory (e.g., flash), peripherals 244 (such as a temperature sensor or I/O modules), and a battery 246. The radio antennae 208 may be within the housing 202 or external to the housing 202, and may be connected to the radio chip 204 by appropriate components, or may be integrated on the radio chip 204.

The radio device 200 and/or radio chip 204 can contain other components, such as buses, crystals, digital logic, analog circuitry, discrete active components, discrete passive components, further processors, user interface components, etc. which are not shown in FIG. 2 for the sake of simplicity. The radio device 200 may be a component of a larger device, such as a car or a domestic appliance, or it may be a standalone radio device.

In use, software is executed by the baseband controller 206 to perform a two-way phase-based ranging process.

The radio devices 1, 2 contain complementary software and/or hard-wired logic for carrying out their respective parts of the ranging process. A resulting distance estimate, d, calculated by the initiator device 1 (or by the reflector device 2) may be output to the system processor 240 for further use, or it may be stored or further processed within the radio chip 204.

Each device 1, 2 may transmit a respective unmodulated carrier signal within a radio data packet. In some embodiments, the data packet is Gaussian frequency-shift-key (GFSK) encoded. The data packet may conform to a current or future Bluetooth™ specification. It may be a Bluetooth™ Low Energy (BLE) packet. The unmodulated signal may occupy only a portion of the packet—e.g. being preceded by a packet preamble and/or followed by further elements of the data packet, such as message data.

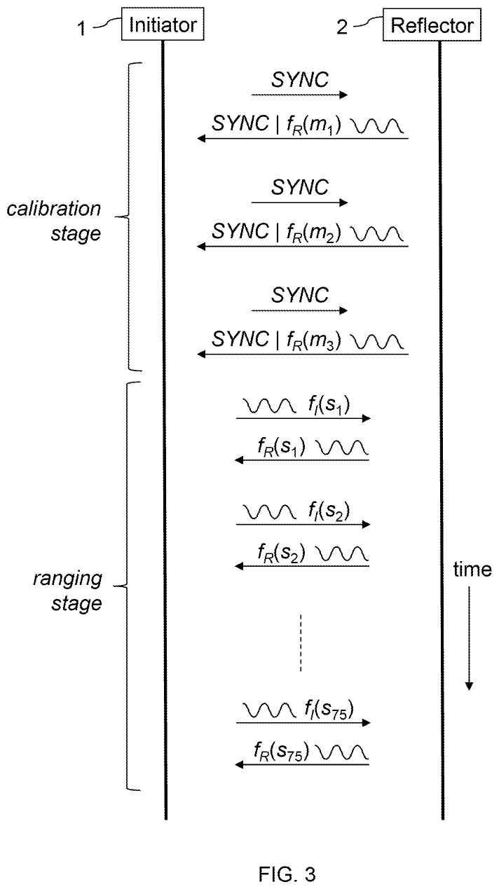

FIG. 3 is a flowchart showing the main steps of an exemplary two-way phase-based ranging process.

The process is divided into two phases: a calibration stage followed by a ranging stage. The calibration stage in this example involves three steps, while the ranging stage involves seventy-five steps. However, these numbers may of course be varied.

In each step of the calibration stage, the initiator device 1 sends a synchronization data packet to the reflector device 2. The reflector 2 responds after a predetermined delay by sending a data packet that includes a synchronization preamble followed by an unmodulated carrier signal. The reflector 2 sets its local oscillator 214 to a different carrier frequency at each step, here denoted f_{R}(m₁), f_{R}(m₂) and f_{R}(m₃). The succession of calibration frequencies and their timings are agreed in advance between the devices 1, 2. In the calibration stage, each unmodulated carrier signal is transmitted for a duration of approximately 100 or 150 μs. This corresponds to a few hundred-thousand cycle periods for carriers in the 2.4 GHz band.

Herein, the start and end times of the unmodulated carrier transmitted by the initiator 1 for each step are denoted as t_{I}¹[k] and t_{I}²[k], and the start and end times of the unmodulated carrier transmitted by the reflector 2 for each step are denoted t_{R}¹[k] and t_{R}²[k]. The total duration of the calibration and ranging stages can be denoted Tₜₑₛₜ with time t=0 corresponding to the start of the first transmission within the ranging procedure.

In each step of the ranging stage, the initiator 1 sends an unmodulated carrier signal to the reflector 2, which responds, after a predetermined delay, with an unmodulated carrier signal having the same nominal frequency as the signal transmitted by the initiator 1. The carrier frequencies sent by the initiator 1 vary across the steps according a time and frequency schedule that is agreed in advance between the devices 1, 2. These frequencies are here denoted f_{I}(s₁), f_{I}(s₂), . . . , f_{I}(s₇₅). Although the reflected frequencies, f_{R}(s₁), f_{R}(s₂), . . . , f_{R}(s₇₅), should be the same, in practice they will differ due to frequency instability in both devices 1, 2 (e.g. caused by temperature-related drift of their respective crystal oscillators). In the ranging stage, each unmodulated carrier signal is transmitted for a respective duration which could be as short as 1 or 10 μs. This corresponds to a few thousand cycle periods for carriers in the 2.4 GHz band.

At each calibration step, the initiator 1 sets its local oscillator 214 based on the expected frequency f_{R} and determines a fractional frequency offset (FFO) (e.g. a value in parts per million) between the incoming signal and the output of its local oscillator signal. The local oscillator 214 could be set to exactly f_{R} (i.e. a zero-IF) or to frequency that is offset by a planned intermediate frequency (e.g. low-IF reception). It selects one of these FFO values, or averages them, to determine a frequency adjustment factor.

At each ranging step, the initiator 1 uses the determined frequency adjustment factor to adjust its local oscillator 214 so that the frequency f_{I} that the initiator 1 transmits will more closely match the response frequency f_{R} that the reflector 2 will output in response.

In the ranging steps, when receiving incoming unmodulated signals, each device 1, 2 sets its local oscillator 214 to the expected incoming frequency (adjusted by the frequency adjustment factor in the case of the initiator 1, and offset any non-zero intermediate frequency if additional downmixing is performed in the digital domain) and measures a phase offset between the incoming signal and the local-oscillator output. At the end of the ranging stage, the reflector 2 sends a data packet containing all of its phase measurements to the initiator 1, which combines them with the phase measurements it made in order to calculate an estimate of the distance d according to a conventional algorithm.

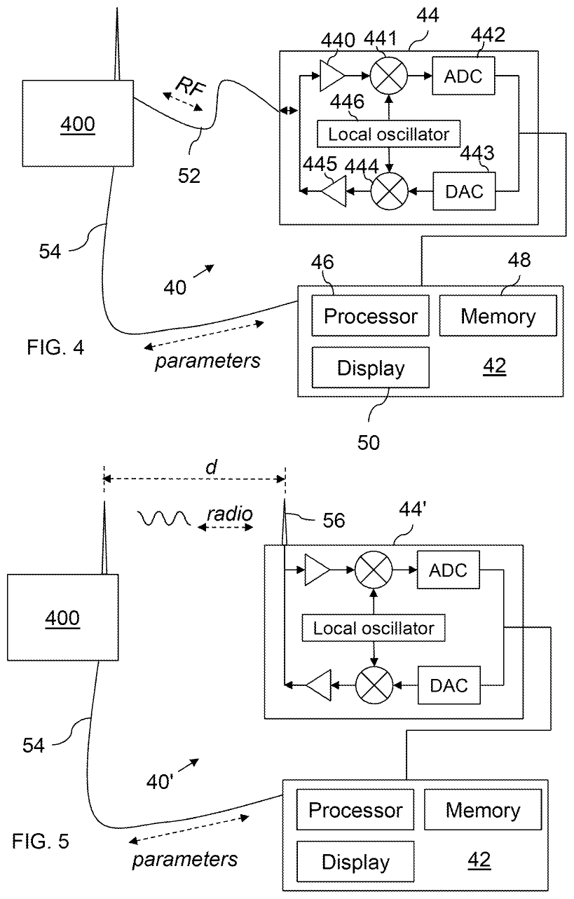

FIG. 4 shows an analysis apparatus 40, embodying the invention, for testing the frequency stability of a radio transceiver device 400, which could be a device like that the device 100 of FIG. 2. The device 400 is configured to act either as an initiator 1 or as a reflector 2 in a two-way phase-based ranging process for the purposes of testing its frequency stability. However, rather than transmitting during the ranging steps, as a partner device normally would, the analysis apparatus 40 instead receives a signal from the device 400 under test, at the same frequency as the partner device would normally transmit, as explained below. This allows the apparatus 40 to capture frequency drift and phase noise of the device 400 under test during reception without requiring the apparatus 40 to receive reception measurements from the device 400 itself. As the respective local oscillators should be same between transmission and reception (except for a potential non-zero IF), the transmission phase noise should be same as for reception.

The analysis apparatus 40 comprises a processing unit 42, such as a desktop computer, and a sampling unit 44, which could be integrated with the processing unit 42 or housed separately and connected by an electrical cable. The processing unit 42 comprises a processor 46, memory 48 storing software for execution by the processor 46, and a display 50. It may also have other components, such as a power supply, interfaces, etc. The sampling unit 44 provides an RF receive path comprising an LNA 440, a receive mixer 441 and an ADC 442, and an RF transmit path comprising a DAC 443, a transmit mixer 444, an RF amplifier 445. It may include other components such as filters, an FSK modulator and/or demodulator, etc. The mixers 441, 444 receive RF mixing signals generated by a variable local oscillator 446. The sampling unit 44 includes control circuitry for changing the frequency of the local oscillator 446 in response to control signals from the processing unit 42. The ADC 442 can output sampled digital data to the processing unit 42, while the DAC 443 can receive digital data from the processing unit 42 for up-mixing to radio frequency.

The analysis apparatus 40 is arranged to perform a conducted test. It is coupled to the radio-frequency transmit and receive paths of the transceiver device 400 by a first electrical cable 52. The antenna of the transceiver device 400 under test may be replaced with a RF connector for connecting the cable 52. Alternatively, the cable 52 may be connected to any convenient point between the antenna and the transmit-path and receive-path mixers 224, 212. The device 400 may have an RF switch connector that isolates the conducted path between the device 400 and its antenna, and bypasses the signal to the analysis apparatus 40. The cable 52 carries radio-frequency (RF) analog signals to and from the sampling unit 44.

The analysis apparatus 40 of this embodiment is also coupled to the transceiver device 400 by a second electrical cable 54 for carrying digital data between the analysis apparatus 40 and the transceiver device 400. It may be connected to an input peripheral 244 of the transceiver 400, such as a USB interface peripheral, for communicating test-parameter data, such as timing and frequency parameters, between the processor 46 of the analysis apparatus 40 and a system processor 240 or baseband controller 206 of the transceiver device 400.

In some variant embodiments, the sampling unit 44 may only provide an RF receive path and not have the capability to transmit RF signals to the radio transceiver device 400. The sampling unit 44 and processing unit 42 may thus be provided by a signal analyzer.

The analysis apparatus 40 performs a conducted test. However, variant analysis apparatus may be configured to perform a radiated test. The analysis apparatus may employ an antenna-coupling device to improve the received signal strength. The test may be performed in a shielded enclosure to minimize the effects of interferences.

FIG. 5 shows a variant analysis apparatus 40′ that is very similar to the analysis apparatus 40 of FIG. 4 except that the sampling unit 44 has a radio antenna or antenna-coupling device 56 and is arranged to exchange radio-frequency signals wirelessly with the transceiver device 400 that is under test, rather than over an electrical cable. In this case, the distance d between the respective antennas is fixed. The RF signal path delay between the mixer 224 of the device 400 and the mixer 441 of the analysis apparatus 40′ can therefore still be assumed to be constant for the duration of the ranging procedure, and so can be accounted for in the processing of the phase measurements. Again, in some variants, the sampling unit 44′ may be arranged only to receive radio signals and not to transmit radio signal.

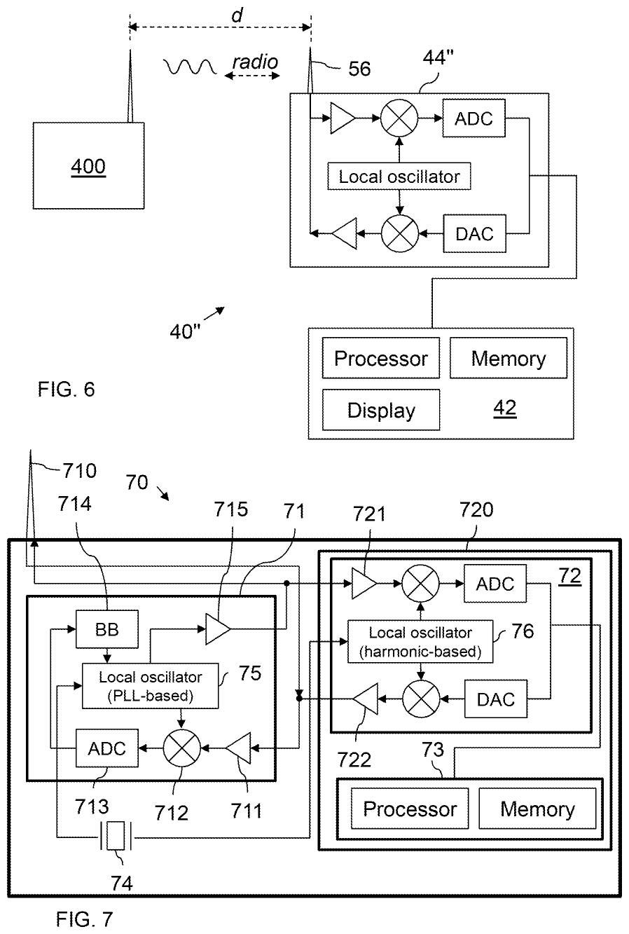

FIG. 6 shows a further variant analysis apparatus 40″ that is very similar to the analysis apparatus 40′ of FIG. 5 except that the analysis apparatus 40″ and transceiver device 400 are arranged to exchange test-parameter data over a wireless link, rather than over an electrical cable.

In another set of embodiments, the analysis apparatus is not a separate unit from the radio device under test, but is wholly or partly provided on the radio device itself. This can conveniently enable the device to test itself without the need for external test apparatus. This would not then require external electrical cables or antenna-coupling devices as described above.

FIG. 7 shows an example of such a radio transceiver device 70.

The radio transceiver device 70 comprises radio transceiver circuitry 71, which may be similar to the integrated-circuit radio transceiver chip 204 described with reference to FIG. 2 or a variant thereof. The transceiver circuitry 71 may comprise a baseband processing system, mixers, filters, amplifiers, etc.

The transceiver circuitry 71 provides a receive path involving an LNA 711, arranged to receive incoming RF signals from an antenna 714, a PLL-based local oscillator 75, a mixer 712 and an ADC 713, arranged to output digital signals to a baseband controller 714. It also provides a transmit path from the baseband controller 714, which, in this example, can directly modulate the PLL-based local oscillator 75, so as to cause the local oscillator 75 to output a modulated signal to a power amplifier 715, for transmission from the antenna 710. In other embodiments, the transmit path may include a DAC and quadrature mixer similar to that shown in FIG. 2. The radio transceiver device 70 may contain further features of the radio device 200 of FIG. 2, such as a system processor, peripherals, battery, antennae, etc.

The radio transceiver device 70 also contains analysis apparatus 720, comprising a sampling unit 72 and a processing system 73. The processing system 73 comprises a processor and memory; these may be reserved for the analysis apparatus 720 or they may also be used by the radio transceiver device 70 for other tasks such as general radio communication operations.

The radio transceiver circuitry 71 and analysis apparatus 720 may be integrated on a common chip.

The analysis apparatus 720 is arranged to exchange radio-frequency electrical signals with the radio transceiver circuitry 71, which may be configured to act as an initiator or as a reflector during a frequency-stability analysis test. Test parameter data may also be exchanged internally between components as required.

The radio transceiver circuitry 71 and sampling unit 72 could be clocked entirely independently, e.g. using two different quartz crystal clock sources. However, in this embodiment they are clocked by a common off-chip crystal oscillator 74 (e.g. a 32 MHz crystal) of the radio transceiver device 70. However, it is desirable that the analysis apparatus 720 be at least quasi-unsynchronized in phase from the radio transceiver circuitry 71 under test. When sharing a crystal 74, this can be accomplished by the radio transceiver circuitry 71 and sampling unit 72 having different respective local oscillators 75, 76, which use two different approaches for generating radio-frequency mixing signals.

The local oscillator 75 of the radio transceiver circuitry 71 is used for up-mixing and down-mixing received and transmitted radio signals. This local oscillator 75 contains a phase-locked loop (PLL) and a voltage-controlled oscillator (VCO), which it uses to perform frequency multiplication of a 32 MHz clock signal, received from the off-chip crystal oscillator 74, to generate an RF mixing signal, e.g. having a tunable frequency of around 2.4 GHz.

By contrast, the local oscillator 76 of the sampling unit 72 uses a harmonic-based approach to generate a high-frequency reference signal. It first converts the 32 MHz clock signal from the crystal oscillator 74 to a 32 MHz square wave. This square wave will contain harmonics at radio frequencies. The local oscillator 76 includes a tunable analog bandpass filtering stage that passes an RF sine wave component of the square wave signal at a desired radio frequency. This may comprise one or more dedicated filters, or the filtering may be provided inherently by the finite bandwidth of an LNA 721 of the sampling unit 72 (or the LNA 711 of the transceiver circuitry 71, in embodiments in which the analysis apparatus 72 does not have its own dedicated LNA). The local oscillator 76 thus generates a stable high-frequency reference signal (e.g. a 2,432 MHz harmonic of the 32 MHz square wave). The harmonic-based local oscillator 76 will have different characteristics (e.g. path delay) to the PLL-based local oscillator 75, such that the reference signals may be quasi-decoupled in phase from the mixing signal generated within the radio transceiver circuitry 71. While they may share flicker noise close to the carrier frequency, the PLL-based local oscillator 75 can act as a source of higher-frequency phase noise. They can therefore be used as reference signals within the sampling unit 72 for determining information about the frequency stability of the radio transceiver circuitry 71, despite ultimately originating from the same crystal 74.

Although FIG. 7 shows the transceiver circuitry 71 as being distinct from the sampling unit 72, in some embodiments they may share components on their receive and/or transmit paths. For example, if the device 70 supports only half-duplex (not full-duplex) communication, the sampling unit 72 need not necessarily have its own LNA 721 and power amplifier (PA) 722, with the LNA 711 and PA 715 of the transceiver circuitry 71 also acting as LNA and PA for the sampling unit 72, since the sampling unit 72 will be receiving only when the transceiver circuitry 71 is in transmission mode and vice versa.

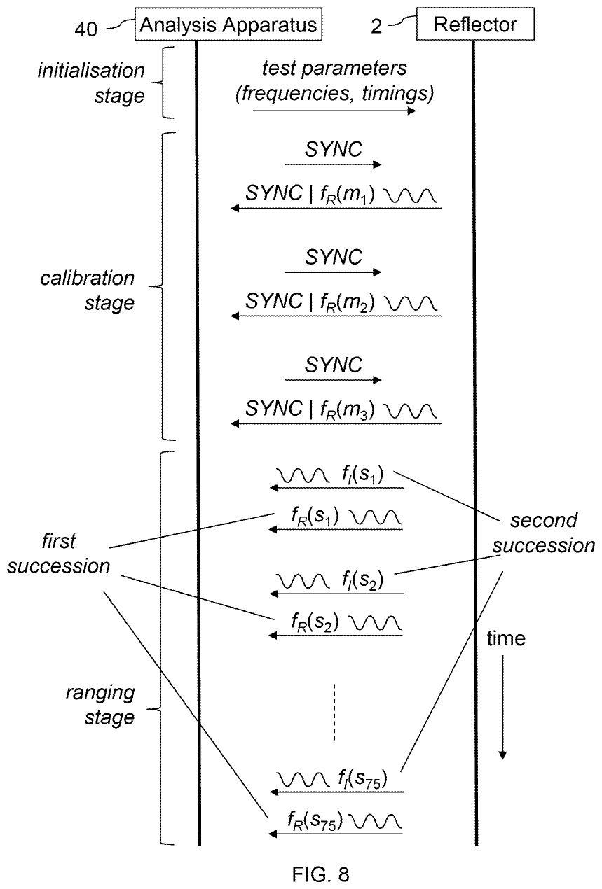

FIG. 8 shows the steps in an exemplary test method performed by the analysis apparatus 40 for testing the frequency stability of the transceiver device 400 when the device 400 is configured to behave as a reflector device 2 in a multicarrier phase-based ranging process. Essentially the same method may also be performed by any variant analysis apparatus 40′, 40″, 40′″ for the transceiver device 400, or by the integrated analysis apparatus 720 for the radio transceiver circuitry 71 of the radio transceiver device 70.

During an initialization phase, the analysis apparatus 40 sends test parameters to the reflector 2 over the data link 54 specifying the frequencies and timings to use during the process.

During a calibration stage, the reflector 2 generates a succession of unmodulated radio-frequency carrier signals, f_{R}(m₁), f_{R}(m₂), and f_{R}(m₃), having frequencies and timings according to the received parameter data. It sends these in response to respective SYNC messages transmitted from the analysis apparatus 40.

The reflector 2 then moves to a ranging stage in which it generates a first succession of unmodulated radio-frequency carrier signals f_{R}(s₁), f_{R}(s₂), . . . , f_{R}(s₇₅), having frequencies and timings according to the received parameter data. It would normally send these in response to incoming unmodulated messages from an initiator device. However, as explained above, when under test, the reflector 2 transmits a second succession of unmodulated radio-frequency carrier signals f_{R}(s₁), f_{R}(s₂), . . . , f_{R}(s₇₅), before each corresponding first-succession signal, to the analysis apparatus 40, instead of receiving such signals.

The reflector 2 may transmit the signals from its antenna 208 during the testing, or it may disconnect part of its transmit path when in a test mode, so that it only outputs electrical RF signals when using an analysis apparatus 40 that is connected by a wired RF connection.

The sampling unit 44 receives the RF signals generated by the reflector 2 at each step, and the analysis apparatus 40 processes them as detailed below to calculate a set of frequency-stability values for the reflector 1.

A very similar process can be used with the analysis apparatus 40′ of FIG. 5 or analysis apparatus 40″ of FIG. 6, except that the subsequent processing may need to take account of the distance d.

When using the integrated analysis apparatus 720 of FIG. 7, an internal data link or software API may be used to communicate parameters to the radio transceiver circuitry 71, configured as the reflector 2, in order to specify the required frequencies and timings of the unmodulated radio frequency signals.

Although the reflector 2 is set to operate according to a test mode, in which it transmits radio signals on frequencies according to received test parameters, in some embodiments the analysis apparatus 40, 40′, 40″, 720 may be configured to transmit radio-frequency signals to the reflector 2 (over an electrical cable, or as radio waves, or over one or more internal lines) corresponding to the initiator 1 role of a normal, full phase-based ranging process, at least during the calibration stage, e.g. as shown in FIG. 3, including agreement over frequency hopping and timings. In this way, the reflector 2 need not necessarily be configured to operate differently when under test as when implementing the ranging process with another transceiver device 1. However, as this may require the analysis apparatus to be more complex in order to support bidirectional RF communications, it is not done in all embodiments.

The processing carried out by the software on the processing unit 42 or the processing system 73 will now be described.

Assuming the testing process involves K transmission steps in total, k=1, . . . , K, of which the first M are calibration steps, m=1, . . . , M, followed by S ranging steps, s=1, . . . , S, i.e. where K=M+S, then the start time of the unmodulated carrier transmitted by the reflector 2 in each step, k, can be denoted as t_{R}¹[k] and the corresponding end time as t_{R}²[k]. The start and end times of the corresponding unmodulated carrier transmissions that would normally be transmitted by an initiator device are here denoted as t_{I}¹[k] and t_{I}²[k]. The total duration of the calibration and ranging stages can be denoted Tₜₑₛₜ, with ϕ_{R}(t) being the phase of the signal transmitted by the reflector 2 over time, t, across the K steps of the whole testing process, where time t=0 corresponds to the start of the first transmission of the first calibration step.

Let f₀(m) denote the nominal frequency of the unmodulated carrier used in each step m of the calibration stage, and f₀(k) denote the nominal frequency of the carrier used for each step k of the ranging stage.

The average frequency of the unmodulated carrier as actually transmitted by the reflector 2 over the interval of a particular step, k, is denoted f_{R}(k).

The analysis apparatus 40 uses a local oscillator that is highly accurate and stable, and so true to the nominal frequencies. It can therefore accurately determine a fractional frequency offset, FFO_{R}(m), from the signal it receives from the reflector 2 in each calibration step m=1, . . . , M, which is equal to

$${FFO}_{R} ( m ) = \frac{{f}_{R} ( m ) - {f}_{0} ( m )}{{f}_{0} ( m )} .$$

In embodiments where the analysis apparatus 720 is located on the transceiver device 70, the analysis apparatus 720 uses a local oscillator 76 generated by filtering a high-frequency harmonic, corresponding to the expected nominal carrier frequency, derived from a crystal oscillator 74, as described above with reference to FIG. 7. The received signal from the radio circuitry 71 of the transceiver device 70 may have also been generated from the same crystal oscillator 74, but instead using a phase-locked loop to increase the frequency of the signal. Due to the differences between the processes used in their generation, the two local oscillator signals will not exhibit the same frequency stability behavior. This makes the local oscillator 76 of the analysis apparatus 720 suitable for use as a reference signal for determining frequency stability.

When implementing these methods by a self-testing transceiver device 70, the fractional frequency offsets FFO_{R}(m) may still be determined against a reference signal in some embodiments. However, in other embodiments, the FFO_{R}(m) values may all be set to be zero. In embodiments in which it is possible to tune the filter of the local oscillator 76, non-zero FFO_{R}(m) values may be used by the integrated analysis apparatus 720 to generate FFO-adjusted reference signals, while in other embodiments the reference signals may be unadjusted.

The analysis apparatus 40 uses each of the measured FFO values, FFO_{R}(m), in turn, to determine a corresponding set of expected actual transmission frequencies from the reflector 2 over the steps k, wherein each set of transmission frequencies assumes a different particular fractional frequency offset, FFO_{R}(m), between the local oscillator of the reflector 2 and the nominal frequencies. The m sets of k expected frequencies are collectively denoted \hat{f}_{R}(m,k), and are given by

\hat{f}_{R}(m,k)=f₀(k)(1+FFO_{R}(m)).

The processor 46 calculates a frequency stability measure for the whole test ranging process by calculating a standard deviation of phase offset over the whole process, as follows.

For each FFO value, m, and at each step, k, the sampling unit 44 mixes the received RF signal with a local-oscillator signal set according to the expected frequency \hat{f}_{R}(m,k), mixing to baseband or to a low intermediate frequency, and then samples the down-mixed signal, to generate complex-valued I and Q sample data. In some embodiments, the analysis apparatus 40 may be able to observe the whole band of frequencies simultaneously, and so not need to explicitly shift its analog local oscillator (LO), but can instead apply the shift digitally—e.g. if the LO of the analysis apparatus 40 is set at 2440 MHz and the current signal is at 2478 MHz, the processor 46 may correct for the 38 MHz offset. The sampling unit 44 passes the samples to the processor 46. The processor 46 may, in some embodiments, determine phase offsets from the I,Q samples at a sampling period of 1 μs; for an unmodulated signal lasting 30 μs, for example, this would yield around thirty samples. The processor 46 calculates the standard deviation of the phase offset over one unmodulated signal step. The processor 46 then combines these standard deviations of the phase offsets, calculated for each of the k steps, to estimate a single standard deviation which provides a frequency stability measure for the entire process. These calculations will now be explained in more detail.

For each calibration step m, a continuous-time phase offset (or phase error) signal ϕ_{R,ϵ} for each time instant t within the whole test process t ∈ [0,Tₜₑₛₜ] can be represented as

ϕ_{R,ϵ}(m,t)=unwrap(ϕ_{R}(t)−2π.\hat{f}_{R}(m,κ(t)).t),

where κ(t) is a function which returns the step index, k, of the calibration or ranging step scheduled at time t, and unwrap( ) is a phase-unwrapping function.

The phase unwrapping function unwrap( ) may be implemented in accordance with the following pseudocode, for phases θ(1) . . . θ(N):

```
For n=2 to N
  while θ(n) >= θ(n−1) + π
    then θ(n) = θ(n) − 2π
  end while
  while θ(n) < θ(n−1) − π
    then θ(n) = θ(n) + 2π
  end while
```

This phase offset represents the difference between the phase, over time, received from the reflector 2 by the analysis apparatus 40, and the phase of a reference signal of the expected frequency generated by the analysis apparatus 40, for a particular FFO adjustment factor, assuming the reflector 2 transmitted the succession of carrier waves with perfectly frequency stability. If the reflector 2 had perfect frequency stability, and if all the RF signal delays within the test path could be accounted for (e.g. internal radio delays, cable delays, phase shifts caused by impedance mismatches between the apparatus 40, cable 52 and device 400), the mean phase offset would be constant over each ranging step. However, frequency instability in the reflector 2 will lead to a corresponding instability in the phase offset, reflected in the standard deviation from the mean. This can be determined as follows, without having to correct for the absolute phase.

As noted, for the purposes of testing, the reflector 2 transmits a second succession of unmodulated carriers, in addition to the normal first succession of unmodulated carriers, during the period normally dedicated to an initiator transmission, referred to herein as [t_{I}¹[k], t_{I}²[k]]. If a ranging step normally requires transmission on multiple antennas, it may be sufficient for the purposes of testing to transmit the entire period [t_{I}¹[k], t_{I}²[k]] on a single antenna.

The times t_{I}¹[k], t_{I}²[k], t_{R}¹[k], t_{R}²[k] are corrected by the analysis apparatus 40 using the respective FFO value, m, and are given by

$${\hat{t}}_{X}^{Y} [ m , k ] = \frac{{t}_{X}^{Y} [ k ]}{1 + {FFO}_{R} ( m )}$$

where X=I, R and Y=1,2.

The step-phase offset for step k (i.e. a signal-phase-offset value for the carrier signal of step k) with respect to calibration step m, is given by

$${θ}_{R , ϵ} [ m , k ] = 0.5 * principal ( \frac{1}{{\hat{t}}_{I}^{2} [ m , k ] - {\hat{t}}_{I}^{1} [ m , k ]} {\int }_{{\hat{t}}_{I}^{1} [ m , k ]}^{{\hat{t}}_{I}^{2} [ m , k ]} {ϕ}_{R , ϵ} ( m , t ) dt - \frac{1}{{\hat{t}}_{R}^{2} [ m , k ] - {\hat{t}}_{R}^{1} [ m , k ]} {\int }_{{\hat{t}}_{R}^{1} [ m , k ]}^{{\hat{t}}_{R}^{2} [ m , k ]} {ϕ}_{R , ϵ} ( m , t ) dt )$$

where the function principal (a) returns the principal value of the real angle a by calculating a+2πk where k is an integer chosen so that −π<principal(a)≤π.

The processing unit 42 may evaluate this step-phase-offset value by processing a digital 1 μs sampled version of ϕ_{R,ϵ}(m,t), determined by the processing unit 42 from the output of the sampling unit 44.

It may, in some embodiments, determine these 1 μs sample-period phase values from a non-zero IF analogue signal by passing the in-phase (I) and quadrature (Q) components through anti-alias filters (e.g. of around 1 MHz bandwidth), which are then sampled using the ADC 442 (potentially comprising a first ADC for the I component and a second ADC for the Q component), e.g. at a sampling rate of 16 Msps. The processing unit 42 may then integrate the sampled signals over 1 μs (i.e. a decimation filter) and then digitally down-sample the output to baseband. The phase ϕ is given by the principal value, in the range (−π, π], of the argument of the complex number I(n)+i.Q(n), for each sample period n.

The mean phase offset for the testing procedure, with respect to the calibration step m, is then given by

$${\overline{θ}}_{R , ϵ} [ m ] = \frac{1}{K - M} {\sum }_{k = M + 1}^{K} {θ}_{R , ϵ} [ m , k ]$$

The processing unit 42 uses the signal-phase-offsets to calculate a standard deviation of phase offset for the whole test process, with respect to the FFO(m) determined for each calibration step m, by evaluating

$${θ}_{R , RM S} [ m ] = \sqrt{\frac{1}{K - M} {\sum }_{k = M + 1}^{K} {( {θ}_{R , ϵ} [ m , k ] - {\overline{θ}}_{R , ϵ} [ m ] )}^{2}}$$

The processing unit 42 or the processing system 73 may display or otherwise output these m frequency-stability values θ_{R,RMS}[m] for further analysis, e.g. by a human operator, or it may perform a check to ensure that each value is below a predetermined threshold. The processing unit 42 or the processing system 73 may display or output a “pass” indication if all of the frequency-stability values are less than the threshold, or a “fail” indication if any of them is greater than the threshold. In some embodiments, the processing unit 42 may calculate the root-mean-square of a set of θ_{R,RMS}[m] values, determined over a plurality of repetitions of the same test process. It may test whether this root-mean-square value is below a threshold, which may in some embodiments be set at 5.73°. This corresponds to a signal-to-noise ratio (SNR) threshold of 20 dB for estimating a channel frequency response.

Checking for all of the possible frequency adjustment factors within a test process is important if the initiator 1, in the actual ranging process, can select any of the adjustment factors to use for the ranging stage. If the initiator 1 operates differently, e.g. by averaging the M FFO to generate an adjustment factor, then the test process may be modified similarly.

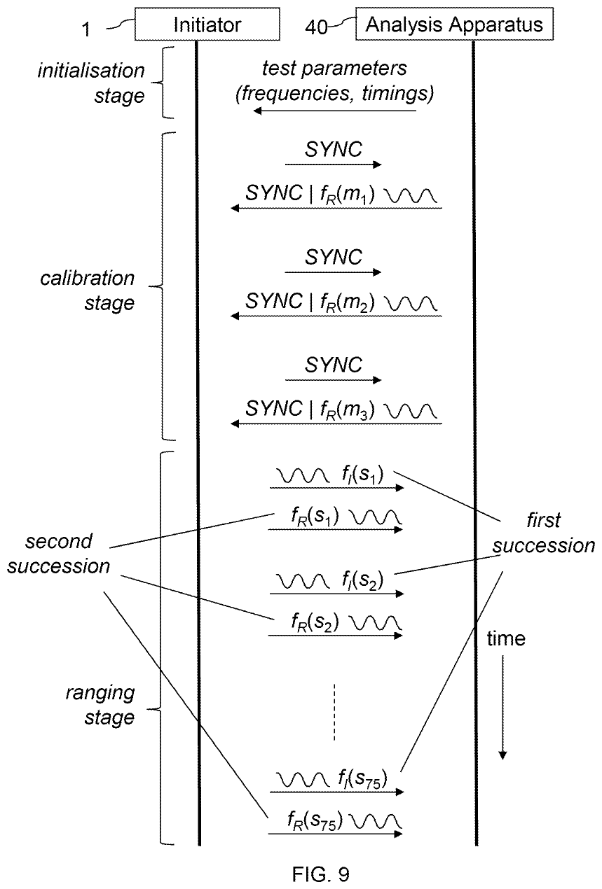

FIG. 9 shows the steps in an exemplary test method performed by the analysis apparatus 40 for testing the frequency stability of the transceiver device 400 (or equivalently by the analysis apparatus 720 on a self-test device 70) when the device 400 is configured to behave as an initiator device 1 in a multicarrier phase-based ranging process.

During an initialization phase, the analysis apparatus 40 sends test parameters to the initiator 1 over the data link 54 (or over an internal hardware or software interface, in the case of a self-test device 70) specifying the frequencies and timings to use during the test process.

If the initiator 1 supports a suitable test mode, calibration transmissions need not be sent in this test method. Instead the initiator 1 may simply use an FFO value provided by the analysis apparatus 40 as part of the parameter data, in place of a frequency adjustment factor that it would normally determine during the calibration stage when performing the ranging with an actual reflector transceiver device 2. Testing could therefore proceed directly to the ranging stage, in which the initiator 1 generates a succession of unmodulated radio-frequency carrier signals, f_{I}(s₁), f_{I}(s₂), . . . , f_{I}(s₇₅), that are FFO-adjusted versions of the frequencies encoded in the parameter data. However, the analysis apparatus 40 may, in other embodiments, engage in a calibration stage, as shown in FIG. 9, in which the analysis apparatus 40 sends calibration transmissions to the initiator 1, intentionally using a desired FFO value. This may help ensure the proper operation of the initiator 1 under test. In either case, the analysis apparatus 40 uses the same FFO adjustment value for all of its transmissions during the ranging stage. The analysis apparatus may potentially perform the whole analysis process multiple times, using a different FFO value each time—e.g. −50 ppm, 0 ppm, and 50 ppm.

The sampling unit 44 receives a first succession of RF ranging signals, generated by the initiator 2 at each step of the ranging stage, and the analysis apparatus 40 processes them as follows to calculate a frequency-stability value for the initiator 2.

The average frequency of the unmodulated carrier, as actually transmitted by the initiator 1, over the interval of a particular step, k, is denoted f_{I}(k).

If the initiator 1 performs a calibration process, rather than using a provided FFO parameter, then, within each calibration step m=1, . . . , M, the initiator 1 measures the average frequency of the unmodulated carrier sent by the analysis apparatus 40. Denote this measured average frequency as f̅_{R}(m). The initiator 1 uses each measurement to calculate an estimate of the fractional frequency offset for a particular calibration step. Denote this measured fractional frequency offset as FFO_{R}(m). It is given by

$$( m ) = \frac{{\tilde{f}}_{R} ( m ) - {f}_{0} ( m )}{{f}_{0} ( m )} .$$

For each of the steps within the process, the analysis apparatus 40 determines an expected frequency \hat{f}_{I}(m,k) of the unmodulated carrier transmitted by the initiator 1 for each carrier index, which the initiator 1 has adjusted using a particular frequency adjustment factor [symbol] (m), calculated by the initiator 1 from the set of synthesized calibration tones generated by the analysis apparatus 40. This expected frequency \hat{f}_{I}(k) is given by

\hat{f}_{I}(m,k)=f₀(k)(1+ [symbol] (m)).

The analysis apparatus 40 uses essentially the same procedure for measuring the standard deviation of the phase offset for the reflector 2 as described above for the initiator 1, except that it is done for only one FFO estimate, using the primary adjustment factor [symbol] (m₀).

For each step, a continuous-time phase-offset signal ϕ_{l,ϵ} for each time instant t within the whole test process t ∈ [0,Tₜₑₛₜ] can be represented as

Ψ_{I,ϵ}(m,t)=unwrap(ϕ_{I}(t)−2π(\hat{f}_{I}(m,κ(t))+FAE(k)).t)

where FAE(k) is a frequency actuation error value, in Hertz, provided by the initiator 1 for step k, and κ(t) is as defined above. This FAE(k) value represents the quantization error arising due to the limited ability of the transceiver device 1 to quantize its local-oscillator (LO) frequency, e.g. representing a minimum LO step size of 2 kHz.

This phase offset represents the difference between the actual phase, over time, received from the initiator 1 by the analysis apparatus 40, and the phase of a reference signal of the expected frequency generated by the analysis apparatus 40, given the adjustment factor [symbol] (m) being applied by the initiator 1, assuming the initiator 1 transmitted the succession of carrier waves with perfectly frequency stability.

For the purposes of testing, the initiator 1 is configured to transmit a second succession of unmodulated carriers, in addition to the normal first succession of unmodulated carrier, during the periods normally dedicated to the reflector transmission, i.e. [t_{R}¹[k],t_{R}²[k]]. If a ranging step requires transmission on multiple antennas, it may be sufficient for the purposes of testing to transmit the entire period [t_{R}¹[k],t_{R}²[k]] on a single antenna.

The times t_{I}¹[k],t_{I}²[k], t_{R}¹[k],t_{R}²[k] are corrected using each FFO measurement and are given by

$${\hat{t}}_{X}^{Y} [ m , k ] = \frac{{t}_{X}^{Y} [ k ]}{1 + ( m )}$$

where X=I, R and Y=1, 2.

The step-phase-error for step k (i.e. a signal-phase-offset value for the carrier signal of step k) with respect to calibration step m, is given by

$${θ}_{I , ϵ} [ m , k ] = 0.5 * principal ( \frac{1}{{\hat{t}}_{I}^{2} [ m , k ] - {\hat{t}}_{I}^{1} [ m , k ]} {\int }_{{\hat{t}}_{I}^{1} [ m , k ]}^{{\hat{t}}_{I}^{2} [ m , k ]} {ϕ}_{I , ϵ} ( m , t ) dt - \frac{1}{{\hat{t}}_{R}^{2} [ m , k ] - {\hat{t}}_{R}^{1} [ m , k ]} {\int }_{{\hat{t}}_{R}^{1} [ m , k ]}^{{\hat{t}}_{R}^{2} [ m , k ]} {ϕ}_{I , ϵ} ( m , t ) dt )$$

where the function principal( ) is as defined above.

Similar to when testing a reflector, the processing unit 42 may evaluate this step-phase-offset value by processing a digital 1 μs sampled version of ϕ_{I,ϵ}(m,t), determined by the processing unit 42 from the output of the sampling unit 44.

The mean phase offset for the testing procedure, with respect to the calibration step m, is then given by

$${\overline{θ}}_{I , ϵ} [ m ] = \frac{1}{K - M} {\sum }_{k = M + 1}^{K} {θ}_{I , ϵ} [ m , k ]$$

The processing unit 42 uses the signal-phase-offsets to calculate a standard deviation of phase offset for the whole test process, with respect to the FFO(m) determined for a particular calibration step m, by evaluating

$${θ}_{I , R MS} [ m ] = \sqrt{\frac{1}{K - M} {\sum }_{k = M + 1}^{K} {( {θ}_{I , ϵ} [ m , k ] - {\overline{θ}}_{I , ϵ} [ m ] )}^{2}}$$

The processing unit 42 may display or otherwise output this frequency-stability values θ_{I,RMS}[m] for further analysis, e.g. by a human operator, or it may perform a check to ensure that the value is below a predetermined threshold. The processing unit 42 may display a “pass” if the frequency-stability value is less than the threshold, or a “fail” indication if it is greater than the threshold. In some embodiments, the processing unit 42 may calculate the root-mean-square of a set of θ_{I,RMS}[m] values, determined over a plurality of repetitions of the same test process. It may test whether this root-mean-square value is below a threshold, which may in some embodiments be set at 5.73°. This corresponds to a signal-to-noise ratio (SNR) threshold of 20 dB for estimating a channel frequency response.

It will be appreciated by those skilled in the art that the invention has been illustrated by describing one or more specific embodiments thereof, but is not limited to these embodiments; many variations and modifications are possible, within the scope of the accompanying claims.

We claim:

1. A method for analyzing a frequency stability of a radio transceiver device, the method comprising:
receiving a first succession of unmodulated radio-frequency signals of different frequencies from a radio transceiver apparatus;
for each unmodulated radio-frequency signal, determining a respective time series of phase-offset values, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculating a frequency-stability value, representative of a frequency stability of the radio transceiver apparatus, as a function representative of statistical variation in the signal-phase-offset values determined for the first succession of unmodulated radio-frequency signals.

2. The method of claim 1, wherein the radio transceiver apparatus is configured to perform a multicarrier phase-based ranging process.

3. The method of claim 1, wherein the radio transceiver apparatus supports a Bluetooth™ radio protocol.

4. An analysis apparatus for analyzing a frequency stability of a radio transceiver apparatus, the analysis apparatus comprising:
an input for receiving a first succession of unmodulated radio-frequency signals of different frequencies from a radio transceiver apparatus;
an analog-to-digital converter for generating digital data representative of the first succession of received unmodulated radio-frequency signals; and
a processing system,
wherein the processing system is configured to process the digital data to:
determine a respective time series of phase-offset values for each unmodulated radio-frequency signal, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculate a frequency-stability value, representative of a frequency stability of the radio transceiver apparatus, as a function representative of statistical variation in the signal-phase-offset values determined for the first succession of unmodulated radio-frequency signals.

5. The analysis apparatus of claim 4, comprising a local oscillator and an analog mixer, wherein the analysis apparatus is arranged to use the local oscillator and the analog mixer to down-mix the received unmodulated radio-frequency signals to baseband or to a non-zero intermediate frequency, and wherein the analog-to-digital converter is arranged to sample the down-mixed signals using a clock that is synchronized with the local oscillator.

6. The analysis apparatus of claim 4, configured to determine the reference signals using a frequency adjustment factor representative of a fractional frequency offset between a local oscillator of the radio transceiver apparatus and a nominal frequency.

7. The analysis apparatus of claim 6, configured to determine the adjustment factor from one of more unmodulated radio-frequency signals received from the radio transceiver apparatus during a calibration stage.

8. The analysis apparatus of claim 6, wherein the adjustment factor is predetermined and wherein the analysis apparatus is configured to communicate the adjustment factor to the radio transceiver apparatus to use when transmitting the unmodulated radio-frequency signals to the analysis apparatus.

9. The analysis apparatus of claim 6, configured to use the frequency adjustment factor to determine the frequency of an analog mixing signal, generated by a local oscillator of the analysis apparatus, for receiving unmodulated radio-frequency signals from the radio transceiver apparatus or for transmitting unmodulated radio-frequency signals to the radio transceiver apparatus.

10. The analysis apparatus of claim 4, wherein the processing system is configured to determine the time series of phase-offset values for each unmodulated radio-frequency signal for regular time intervals over the respective unmodulated radio-frequency signal.

11. The analysis apparatus of claim 4, wherein the processing system is configured to process the time series of phase-offset values to determine a respective signal-phase-offset value for each unmodulated signal of the first succession of unmodulated signals by integrating each time series of phase-offset values over a duration of the respective unmodulated signal for the time series.

12. The analysis apparatus of claim 11, wherein the processing system is configured to further process the time series of phase-offset values to determine the respective signal-phase-offset value for each unmodulated signal by determining a respective principal angle of the difference between an integral of the time series of phase-offset values and an integral of a second time series of phase-offset values, wherein the second time series of phase-offset values is representative of a difference between a phase of a second unmodulated radio-frequency signal, received from the radio transceiver apparatus, and a phase of a respective second reference signal.

13. The analysis apparatus of claim 12, configured to receive each respective second unmodulated radio-frequency signal, from the radio transceiver apparatus, in a second succession of unmodulated radio-frequency signals, interleaved in time with the first succession of unmodulated radio-frequency signals.

14. The analysis apparatus of claim 13, wherein respective signals of the first and second successions of unmodulated radio-frequency signals have the same respective frequency.

15. The analysis apparatus of claim 4, wherein the function representative of statistical variation in the signal-phase-offset values equals or is representative of the standard deviation or variance of the signal-phase-offset values for the succession of unmodulated signals.

16. The analysis apparatus of claim 4, wherein the processing system is configured to determine whether the frequency-stability value satisfies a test criterion.

17. The analysis apparatus of claim 4, wherein the reference signals are determined using frequency adjustment factors, and wherein the processing system is configured to calculate a plurality of frequency-stability values for each of a plurality of different frequency adjustment factors, and to determine whether the plurality of frequency-stability values satisfies a test criterion.

18. The analysis apparatus of claim 4, comprising an interface for sending timing data related to times of transmission for the unmodulated radio-frequency signals to the radio transceiver apparatus or for receiving timing data related to times of transmission of the unmodulated radio-frequency signals from the radio transceiver apparatus.

19. The analysis apparatus of claim 4, wherein the radio transceiver apparatus is a radio transceiver device, and wherein the analysis apparatus is separate from the radio transceiver device.

20. The analysis apparatus of claim 19, wherein the input comprises an electrical input for receiving the unmodulated radio-frequency signals as electrical signals from the radio transceiver device over an electrical cable, or wherein the input comprises an antenna or antenna coupler for receiving the unmodulated radio-frequency signals as wireless signals from the radio transceiver device.

21. The analysis apparatus of claim 4, wherein the radio transceiver apparatus is a radio transceiver device, and wherein the radio transceiver device further comprises at least the input and the analog-to-digital converter of the analysis apparatus.

22. The analysis apparatus of claim 21, wherein the radio transceiver device comprises all of the analysis apparatus.

23. The analysis apparatus of claim 21, wherein the analysis apparatus comprises a first local oscillator and the radio transceiver apparatus comprises a second local oscillator, wherein both local oscillators are arranged to receive a common clock signal, and wherein one of the local oscillators is arranged to generate radio-frequency signals from the clock signal using a voltage-controlled oscillator and a phase-locked loop, and the other of the local oscillators is arranged to generate radio-frequency signals as harmonics of the clock signal.

24. A non-transitory computer-readable storage medium storing software instructions which, when executed by a processor, cause the processor to process digital data representative of a first succession of unmodulated radio-frequency signals, received from a radio transceiver apparatus, to:
determine a respective time series of phase-offset values for each unmodulated radio-frequency signal, each phase-offset value being representative of a difference between a phase of the respective received unmodulated radio-frequency signal and a phase of a respective reference signal;
processing the time series of phase-offset values to determine a respective signal-phase-offset value for each unmodulated radio-frequency signal; and
calculate a frequency-stability value, representative of a frequency stability of the radio transceiver apparatus, as a function representative of statistical variation in the signal-phase-offset values determined for the first succession of unmodulated radio-frequency signals.
